(19) United States
(12) Patent Application Publication
(10) Pub. No.: US 2015/0258462 A1
(43) Pub. Date: Sep. 17, 2015

(54) Structure for a Multi-Surface Magnetic Block

(71) Applicant: Zhengpeng WEI, GUANGDONG PROVINCE (CN)

(72) Inventor: Zhengpeng WEI, GUANGDONG PROVINCE (CN)

(21) Appl. No.: 14/298,959

(22) Filed: Jun. 8, 2014

(30) Foreign Application Priority Data
Mar. 17, 2014 (CN) 201410098055.0

(51) Int. Cl. A63H 33/04; A63H 33/26; A63H 33/06; H01F 7/02

(52) U.S. Cl. CPC A63H 33/046; H01F 7/02; A63H 33/26; A63H 33/06

(57) ABSTRACT

The present invention discloses a structure for a multi-surface magnetic block, embedded with magnetic assemblies, wherein the block is embedded with magnetic assemblies, via which assemblies any two blocks can be attached and spliced with each other; the block is formed by assembling sealing covers and a main housing body, and the sealing covers are fixedly connected to the main housing body to form the whole block; the magnetic assemblies are constituted by spherical ball magnets and cavities, the cavities are distributed at the positions in the main housing body adjacent to the sealing covers, and the cavities are encapsulated to be closed cavities after the sealing covers are fixed onto the main housing body; the ball magnets are embedded in the closed cavities with free rotation. The solution greatly improves block manufacturing efficiency, and reduces manufacturing difficulty and cost, thereby having an enhanced practicability and a great market value.

### BACKGROUND OF THE INVENTION

The present invention relates to the technical field of splicing blocks, in particular, toy-dedicated and education-dedicated splicing blocks, to be more specific, magnetic splicing blocks characterized by teaching in joy.

Previously, the invention applicant put forward a wholly new magnetic block different from traditional blocks. Such magnetic block is provided with magnetic assemblies on every surface; multiple surfaces of any block can be engaged in outward magnetic splicing in any direction, and splicing manners are diversified, such that numberless splicing shapes can be realized and transformed. Moreover, the magnetic manner enables the splicing to be more relax and interesting, capable of better helping children to not only acquire knowledge but also enjoy themselves while stacking up blocks, thereby really realizing the educational ideal of teaching in joy. In addition, due to adoption of magnetic assemblies, such magnetic blocks can be adhered to any magnetic panel (e.g., teaching white board), more convenient for teaching, with enhanced practicability.

However, such blocks suffer from the following disadvantages during the manufacturing: numerous and jumbled working procedures, and relatively difficult development of molds, which disadvantages are not favorable for batch productions. Hence, it is necessary to optimize and innovate the internal structure for magnetic blocks.

### BRIEF SUMMARY OF THE INVENTION

To solve the above problems, the present invention intends to provide a structure for a multi-surface magnetic block with optimized structure and easy for manufacturing and assembling.

In order to realize the technical objective, the solution of the present invention is as follows: a structure for a multi-surface magnetic block, the block being a polyhedron, wherein the block is embedded with magnetic assemblies, via which magnetic assemblies any two blocks can be attached and spliced with each other; the block is formed by assembling sealing covers and a main housing body, and the sealing covers are fixedly connected to the main housing body to form the whole block; the magnetic assemblies are constituted by spherical ball magnets and cavities, the cavities are distributed at the positions in the main housing body adjacent to the sealing covers, and the cavities are encapsulated to be closed cavities after the sealing covers are fixed onto the main housing body; the ball magnets are embedded in the closed cavities with free rotation, and can freely adjust directions of magnetic poles.

As a further improvement, the cavities are disposed at corner sites of the main housing body.

As the most preferred embodiment, the block is a six-surface cube, the sealing covers are an upper cover and a bottom cover, and the main housing body is a four-surface housing body; the cavities are distributed at eight angle ends of the four-surface housing body, four cavities at the upper end region are encapsulated by the upper cover into closed cavities, and four cavities at the bottom end region are encapsulated by the bottom cover into closed cavities; each cavity encapsulates a spherical ball magnet.

As a preferred embodiment, the material of the main housing body and the sealing covers can be any one of plastic, wood, sponge, and fiber.

As a preferred embodiment, the sealing covers are connected to the main housing body via screw fixation.

As a preferred embodiment, the sealing covers are fixed to the main housing body via ultrasonic welding.

As a preferred embodiment, the sealing covers are fixed to the main housing body via structural fastening.

The present solution divides a multi-surface magnetic block into a main housing body and sealing covers for assembling; the main housing body encapsulates closed cavities via the sealing covers, and the cavities are provided with spherical ball magnets, thereby realizing the magnetic function of free transformation of magnetic poles, and ensuring any attachment among blocks, which is characterized by excellence in structural design, and connecting stably and processing and installing with ease; the whole solution greatly improves manufacturing efficiency of blocks, and reduces manufacturing difficulty and cost, thereby having an enhanced practicability, and having a great market value.

### BRIEF DESCRIPTION OF THE DRAWINGS

FIG. 1 is a schematic diagram of the stereoscopic structure for Embodiment One of the present invention;

FIG. 2 is an exploded view of the structure for Embodiment One of the present invention;

FIG. 3 is a schematic diagram of the stereoscopic structure for Embodiment Two of the present invention;

FIG. 4 is an exploded view of the structure for Embodiment Two of the present invention;

FIG. 5 is a schematic diagram of the stereoscopic structure for Embodiment Three of the present invention;

FIG. 6 is an exploded view of the structure for Embodiment Three of the present invention;

FIG. 7 is a schematic diagram of the stereoscopic structure for Embodiment Four of the present invention;

FIG. 8 is an exploded view of the structure for Embodiment Four of the present invention;

FIG. 9 is a schematic diagram of the stereoscopic structure for Embodiment Five of the present invention;

FIG. 10 is an exploded view of the structure for Embodiment Five of the present invention;

FIG. 11 is a schematic diagram of the stereoscopic structure for Embodiment Six of the present invention;

FIG. 12 is an exploded view of the structure for Embodiment Six of the present invention;

FIG. 13 is a schematic diagram of the stereoscopic structure for Embodiment Seven of the present invention;

FIG. 14 is an exploded view of the structure for Embodiment Seven of the present invention;

FIG. 15 is a schematic diagram of the stereoscopic structure for Embodiment Eight of the present invention;

FIG. 16 is an exploded view of the structure for Embodiment Eight of the present invention.

### DETAILED DESCRIPTION OF THE INVENTION

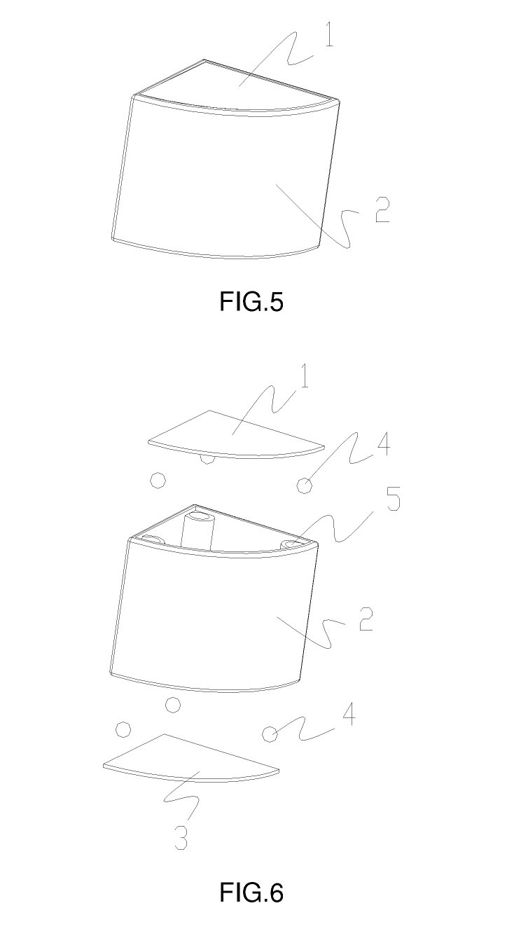

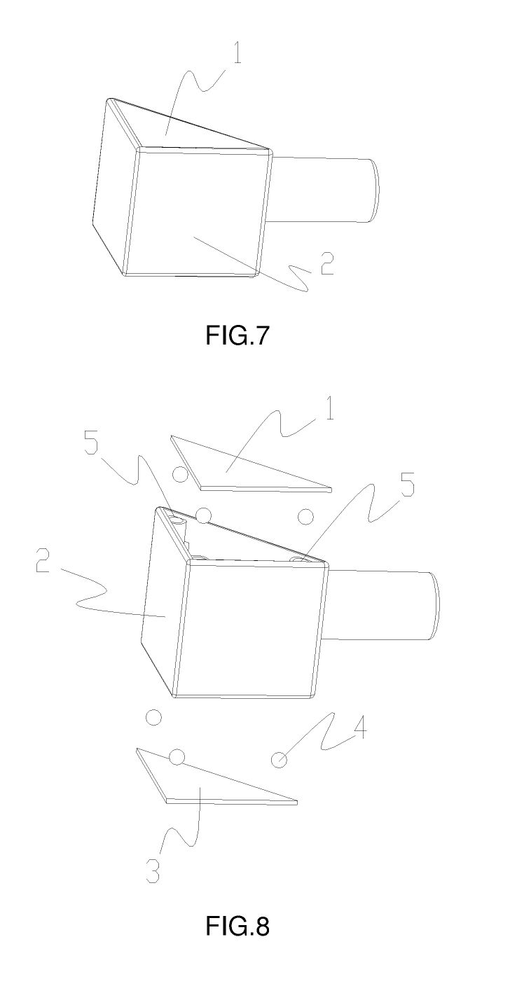

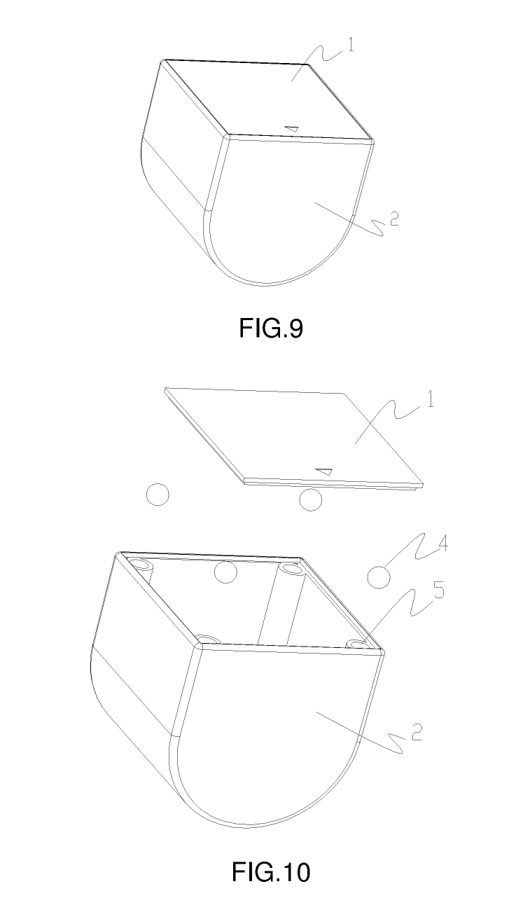

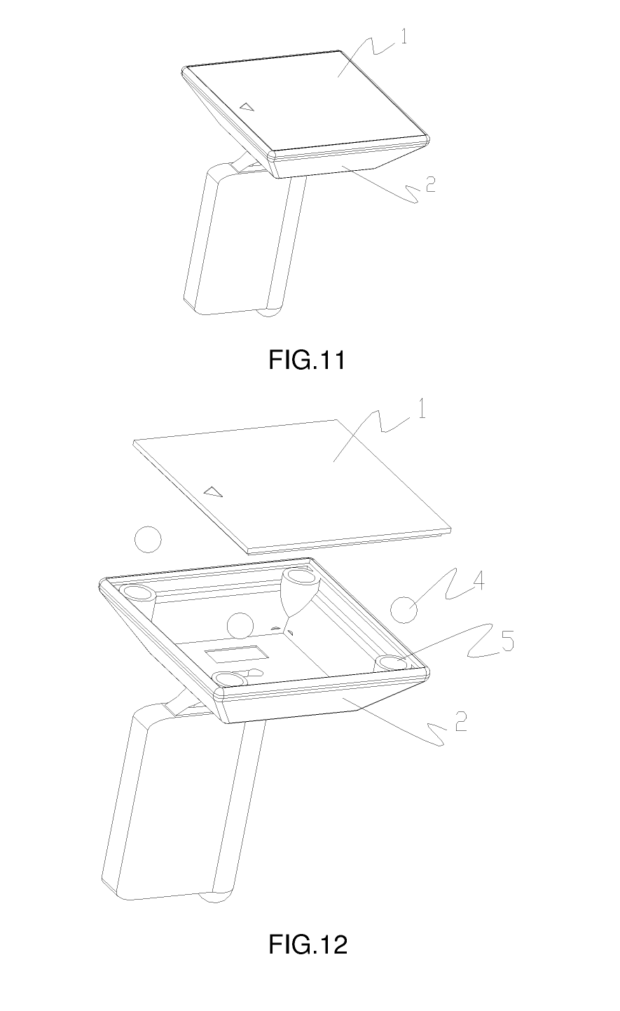

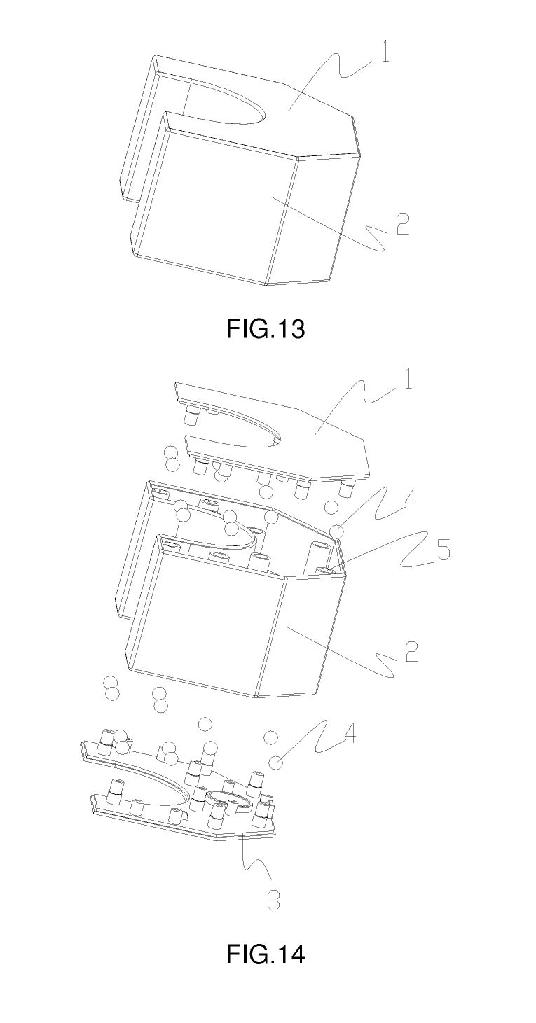

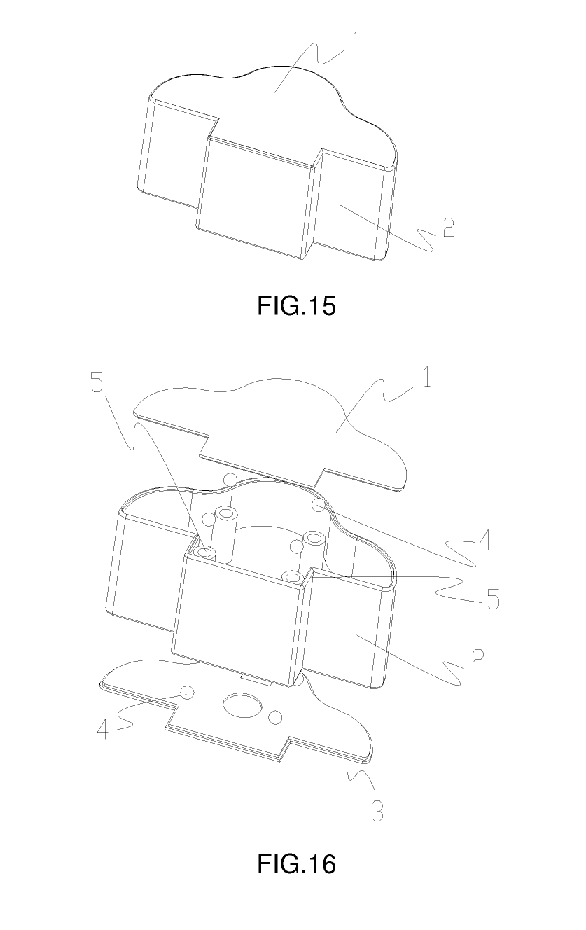

The present invention relates to a structure for a multi-surface magnetic block, wherein the block is a polyhedron, as shown in FIGS. 1, 3, 5, 7, 9, 11, 13, and 15, can be a cube, a sector, or a trapezoid, etc.; specific shapes can be designed according to toy needs. The main objective of the present invention is to reduce manufacturing difficulty and cost of magnetic blocks, thereby realizing batch production of blocks with high efficiency, high yield rate and low cost.

The blocks of the present invention are embedded with magnetic assemblies, as shown in FIGS. 1 to 16, via which magnetic assemblies any two blocks can be attached and spliced with each other; the block is formed by assembling sealing covers and a main housing body 2, wherein the sealing covers can be a single sealing cover, can also be an upper cover 1 and a bottom cover 3, and can also be more sealing covers, depending on specific block structures; the sealing covers are fixedly connected to the main housing body 2 to form the whole block. The magnetic assemblies are constituted by spherical ball magnets 4 and cavities 5, the cavities 5 are distributed at the positions in the main housing body adjacent to the sealing covers, and the cavities 5 are encapsulated to be closed cavities after the sealing covers are fixed onto the main housing body 2; the ball magnets are embedded in the closed cavities with free rotation, and can freely adjust directions of magnetic poles; when two surfaces of two blocks come close to each other, if the same sides are N-S poles, the magnets are in a repulsion relation to each other, and then the spherical ball magnets 4 will rotate in the cavities, and automatically adjust themselves to a position where the magnetic poles attract each other, thereby ensuring that any two blocks can be attached and spliced with each other via magnetic force.

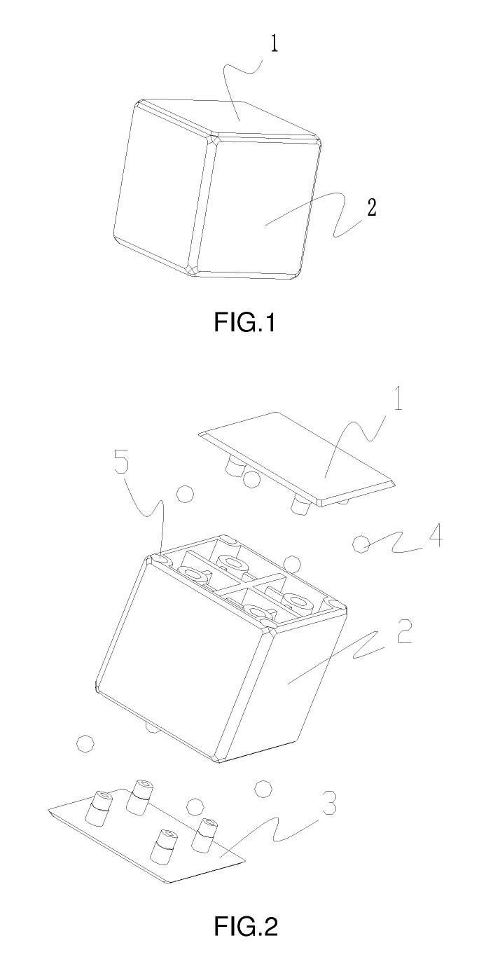

As for the positions where the cavities 5 are specifically arranged, the best embodiment provides corner sites of the main housing body 2, as shown in FIGS. 2, 4, 6, 8, 10, 12 and 16; certainly, in order to enhance direct attachment force between blocks so as to pursue a great connecting stability, as shown in FIG. 14, some cavities are distributed at non-corner sites.

Now, the cube block is taken as the best embodiment of the present invention, with detailed depictions as follows.

As shown in FIG. 2, in the structure for the multi-surface magnetic block of the present invention, the block is formed by assembling an upper cover 1, a bottom cover 3 and a four-surface housing body as a main housing body 2; the magnetic assemblies are constituted by spherical ball magnets 4 and cavities 5, and the spherical ball magnets 4 are embedded in the cavities 5 with free rotation, and freely adjust directions of magnetic poles; the cavities 5 are distributed at eight angle ends of the four-surface housing body, four cavities 5 at the upper end region are encapsulated by the upper cover 1 into closed cavities, and four cavities 5 at the bottom end region are encapsulated by the bottom cover 3 into closed cavities; each cavity 5 encapsulates a spherical ball magnet 4.

During actual manufacturing, the sealing covers can be fixed to the main housing body 2 via screw fixation, ultrasonic welding or structural fastening, or certainly, via other manners in the prior art. All these manners are equivalent replacements of the present invention.

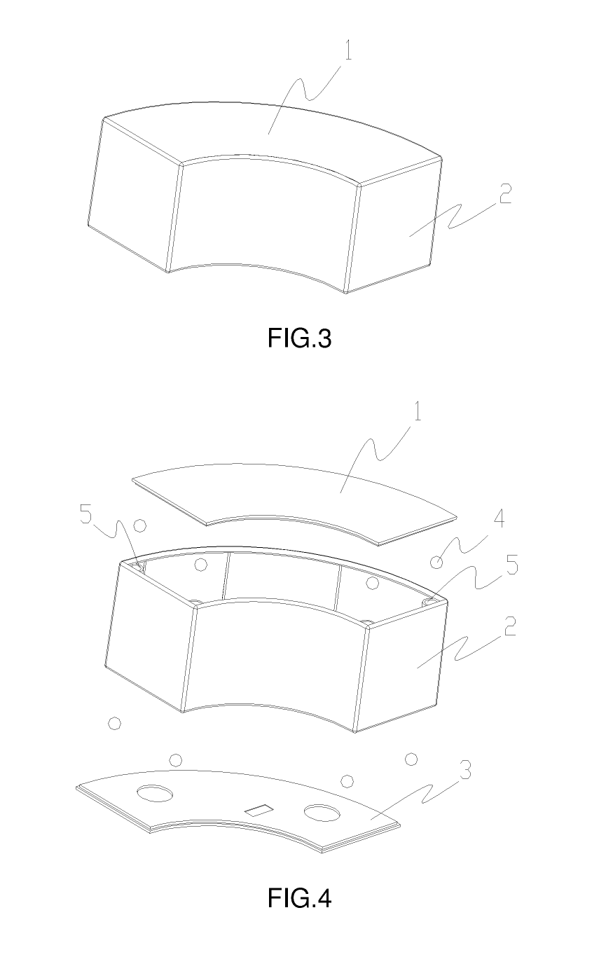

Likewise, Embodiment Two to Embodiment Eight, as shown in FIGS. 3-16, represent specific structures of blocks with different shapes, whose technical characteristics are completely identical to those of the aforesaid best embodiment, and which are only applications aiming at different shapes, so no more details are provided. It should be stressed that, other shapes not shown in the present invention, are also equivalents of the present invention, and still fall within the protection scope of the present invention.

The material of the main housing body and the sealing covers involved in the present invention is a non-magnetic material, such as plastic, wood, sponge, fiber, etc.

All the contents as stated above, are only better embodiments of the present invention, and are not used to limit the present invention; any subtle amendment, equivalent replacement and improvement that is made to the above embodiments according to the technical substance of the present invention, shall fall within the protection scope of the technical solution of the present invention.

What is claimed is:

1. A structure for a multi-surface magnetic block, the block being a polyhedron, characterized in that:
the block is embedded with magnetic assemblies, via which magnetic assemblies any two blocks can be attached and spliced with each other;
the block is formed by assembling sealing covers and a main housing body, and the sealing covers are fixedly connected to the main housing body to form the whole block;
the magnetic assemblies are constituted by spherical ball magnets and cavities, the cavities are distributed at the positions in the main housing body adjacent to the sealing covers, and the cavities are encapsulated to be closed cavities after the sealing covers are fixed onto the main housing body; the ball magnets are embedded in the closed cavities with free rotation, and can freely adjust directions of magnetic poles.

2. The structure for the multi-surface magnetic block according to claim 1, characterized in that: the cavities are disposed at corner sites of the main housing body.

3. The structure for the multi-surface magnetic block according to claim 1, characterized in that: the block is a six-surface cube, the sealing covers are an upper cover and a bottom cover, and the main housing body is a four-surface housing body; the cavities are distributed at eight angle ends of the four-surface housing body, four cavities at the upper end region are encapsulated by the upper cover into closed cavities, and four cavities at the bottom end region are encapsulated by the bottom cover into closed cavities; each cavity encapsulates a spherical ball magnet.

4. The structure for the multi-surface magnetic block according to any one of claims 1 to 3, characterized in that: the material of the main housing body and the sealing covers can be any one of plastic, wood, sponge, and fiber.

5. The structure for the multi-surface magnetic block according to any one of claims 1 to 3, characterized in that: the sealing covers are connected to the main housing body via screw fixation.

6. The structure for the multi-surface magnetic block according to any one of claims 1 to 3, characterized in that: the sealing covers are fixed to the main housing body via ultrasonic welding.

7. The structure for the multi-surface magnetic block according to any one of claims 1 to 3, characterized in that: the sealing covers are fixed to the main housing body via structural fastening.
